(19) United States
(12) Patent Application Publication
(10) Pub. No.: US 2015/0235120 A1
(43) Pub. Date: Aug. 20, 2015

(54) JEWELRY PIECE WITH INTERCHANGEABLE RFID TAG

(71) Applicant: Michael K. Warren, Lancaster, PA (US)

(72) Inventor: Michael K. Warren, Lancaster, PA (US)

(21) Appl. No.: 14/699,668

(22) Filed: Apr. 29, 2015

Related U.S. Application Data
(63) Continuation of application No. 13/827,341, filed on Mar. 14, 2013.
(60) Provisional application No. 61/713,200, filed on Oct. 12, 2012.

(51) Int. Cl. G06K 19/077; G06K 19/07; G06K 7/10; A44C 9/00

(52) U.S. Cl. CPC G06K 19/07762; A44C 9/0061; G06K 19/0702; G06K 7/10009

(57) ABSTRACT

An apparatus for conveniently and unobtrusively carrying a radio frequency identification (RFID) tag. A jewelry piece is operatively connected to a housing using a screw post and threaded slot. A radio frequency identification tag and buffer ring are disposed within the housing and enclosed by a cap.

### CROSS-REFERENCE TO RELATED APPLICATIONS

This application is a continuation of U.S. patent application Ser. No. 13/827,341, filed Mar. 14, 2013, which claims priority from U.S. Provisional Patent Application No. 61/713,200, filed Oct. 12, 2012, the entirety of which are incorporated herein by reference.

### FIELD

The present disclosure generally relates to radio frequency identification (RFID) tags. More specifically, the present disclosure relates to a RFID tag in a jewelry piece.

### BACKGROUND

Radio frequency identification (RFID) tags are used to wirelessly identify an item. A RFID tag typically consists of a microprocessor operatively coupled with an antenna. The microprocessor stores a unique identification code for an item and transmits the code via the antenna as a radio frequency signal. The radio frequency signal is captured by a RFID reader and processed for use. The typical RFID tag is passive, relying on an external stimulus—such as an electromagnetic field produced by a RFID reader—to energize the antenna and transmit the identification code. However, some RFID tags further include a power source, allowing the tag to actively transmit information from the microprocessor.

RFID tags are frequently attached to or embedded in items and used in inventory control, item tracking, manufacturing, transportation and logistics. RFID tags have also proved useful in human applications, such as identity verification and access control. In human applications the RFID tags must be attached to or embedded in an item which is carried by the human, such as an identification card, an access badge, or a key fob. However, each of these items are prone to loss or misplacement, damage, and theft.

One solution to the problem of loss, damage, and theft of RFID items associated with human applications has been borrowed from use in animal inventory control and tracking—injection of an RFID tag under the skin. However, many people find this solution highly objectionable. There is thus a need felt in the art for a convenient but non-objectionable means for a human to carry an RFID tag for use in human applications such as identity verification or access control.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like numerals denote like features throughout specification and drawing.

FIG. 1 is a side view of a jewelry piece with an interchangeable radio frequency identification tag in accordance with some embodiments of the present disclosure.

FIG. 2 is a schematic exploded side view of a jewelry piece with an interchangeable radio frequency identification tag in accordance with some embodiments of the present disclosure.

FIG. 3 is a schematic top view, with components again exploded as in FIG. 2, of a jewelry piece with an interchangeable radio frequency identification tag in accordance with some embodiments of the present disclosure.

FIG. 4 is a schematic cross-section view of an example of the command module in accordance with some embodiments of the present disclosure.

FIG. 5 is a schematic cross-section view of an example of a jewelry piece with an interchangeable radio frequency identification tag in accordance with some embodiments of the present disclosure.

FIG. 6 is a schematic cross-section view of an example of a jewelry piece with an interchangeable radio frequency identification tag in accordance with some embodiments of the present disclosure.

FIG. 7 is a schematic cross-section view of an example of a jewelry piece with an interchangeable radio frequency identification tag in accordance with some embodiments of the present disclosure.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

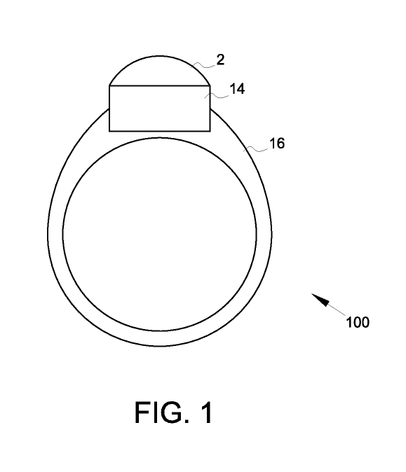

In FIGS. 1 through 6, like items are indicated by like reference numerals and, for brevity, descriptions of a component or structure are not repeated.

The present disclosure provides an apparatus comprising a piece of jewelry connected with an interchangeable radio frequency identification (RFID) tag. The apparatus is provided to enable a user to conveniently and unobtrusively carry a RFID tag with a low probability of loss or damage to the tag.

In some embodiments, the jewelry piece is a ring. However, other jewelry pieces would be suitable for use in accordance with the present disclosure. Specifically, the present disclosure could be used to connect an interchangeable RFID tag with watches, pendants, brooches, earrings and other body piercing jewelry, necklaces, bracelets, amulets, medallions, hairpins, and any suitable jewelry pieces.

There are generally three types of RFID tags: active, passive, and battery-assisted passive. In some embodiments of the present disclosure uses a passive tag, which is generally cheaper and smaller than active or battery-assisted passive tags because it requires no independent power source. A passive tag uses the radio energy transmitted by a RFID reader as its power source. However, any type of RFID tag would be suitable for use with the present disclosure. Use of an active or battery-assisted passive RFID tag requires the addition of an independent power source such as a battery to the disclosed apparatus.

FIG. 1 is a side view of one example of a jewelry piece 100 with an interchangeable RFID tag in accordance with some embodiments of the present disclosure. FIG. 1 shows the exterior of the apparatus with all component pieces assembled. Viewing the exterior, a user or viewer of the apparatus sees a cap 2, a housing 14, and a ring 16, which are described in further detail below.

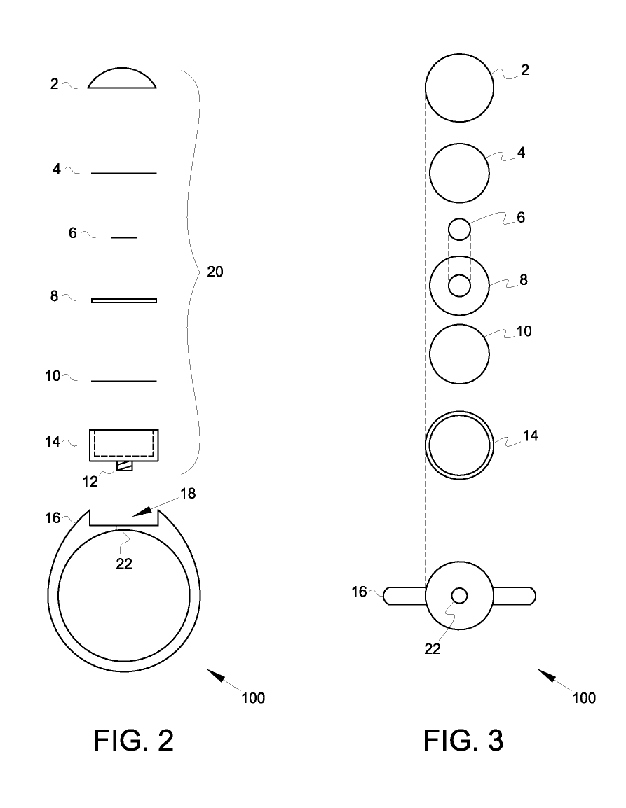

FIG. 2 is a schematic exploded side view of an example of a jewelry piece 100 with an interchangeable RFID tag in accordance with some embodiments of the present disclosure. FIG. 2 illustrates how constituent pieces of the apparatus are fitted together in the illustrated embodiment.

Cap 2 is formed from a gemstone, a synthetic or imitation gemstone, or like material including glass or plastic. Cap 2 is often formed as a “cabochon” having a convex, substantially hemispherical surface and a flat surface. In the alternative, the cap can have a concave surface and a flat surface. The shape of cap 2 can vary, employing any suitable gemstone cutting techniques. Cap 2 is connected to housing 14 by cement, glue, solder, or other suitable adhesive.

Below cap 2 is a RFID tag 6 which may be of any suitable type and configuration but is illustrated as a RFID wafer. RFID tag 6 is disposed within a buffer ring 8. In some embodiments, buffer ring 8 is composed of a ferrite material. Buffer ring 8 is disposed within housing 14. RFID tag 6, buffer ring 8, and the inner diameter of housing 14 are sized to minimize movement of the RFID tag 6 during use of the apparatus.

In some embodiments, the jewelry piece 100 includes one or both of a top spacer 4 and bottom spacer 10 to further minimize movement of RFID tag 6 during use. In some embodiments, top spacer 4 and bottom spacer 10 are composed of a material that does not substantially inhibit radio frequency transmission such as plastic or glass. A material does not substantially inhibit radio frequency transmission if the transmission range is not notably reduced by using that material. Materials that do no substantially inhibit radio frequency transmission, such as glass and plastic, are substantially permissive materials.

In some embodiments, top spacer 4 and bottom spacer 10 are composed of materials which inhibit radio frequency transmission, such as most metal alloys, as a way to limit the range of enclosed RFID tag 6. For example, if RFID tag 6 is readable from a distance of three feet from a jewelry piece 100 without top spacer 4 or bottom spacer 10, but it is desired that RFID tag 6 only be readable at a distance of six inches from jewelry piece 100, then one or both of top spacer 4 and bottom spacer 10 composed of a material which inhibits radio frequency transmission can be added to the jewelry piece 100 to reduce the effective reading range of RFID tag 6.

The unit formed by cap 2, RFID tag 6, buffer ring 8, and housing 14, when connected, is referred to as a command module 20. In some embodiments of the present disclosure, command module 20 is fully interchangeable, meaning a first command module connected to ring 16 can be removed and replaced with a second command module.

Housing 14 is formed from stainless steel, precious metal (gold, silver, platinum, and the like), or any suitable material for forming jewelry, such as carbon fiber or titanium alloys. Housing 14 is sized to fit within a receiving area 18 of ring 16. Housing 14 is connected to ring 16 by a screw post 12, which is a threaded member that is rotatably inserted into a threaded slot 22 in ring 16.

Ring 16 is formed from stainless steel, precious metal (gold, silver, platinum, and the like), or any suitable material for forming jewelry, such as carbon fiber or titanium alloys. Ring 16 includes a receiving area 18 and threaded slot 22 for receiving housing 14 and screw post 12, respectively. Housing 14 and ring 16 can be formed from the same material or different materials.

FIG. 3 is a schematic top view, with components again exploded as in FIG. 2, of a jewelry piece with an interchangeable radio frequency identification tag in accordance with some embodiments of the present disclosure. As in FIG. 2, FIG. 3 illustrates how the constituent components of jewelry piece 100 are fitted together. In the illustrated embodiment, RFID tag 6 is disposed within buffer ring 8, which in turn is disposed within housing 14 along with top spacer 4 and bottom spacer 10. Cap 2 is adhered to housing 14 to form command module 20. Command module 20 is operatively connected to ring 16 via a screw post 12 (not visible in FIG. 3) rotatably inserted into threaded slot 22.

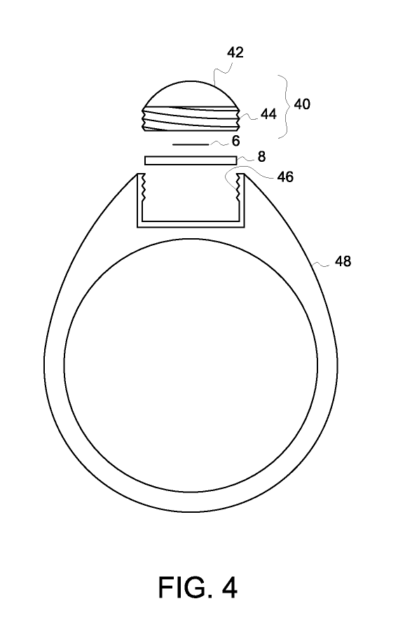

Referring now to FIG. 4, in some embodiments, cap 40 comprises a top 42 connected to a threaded member 44 which can be rotatably inserted into a threaded recess 46 on ring 48. Top 42 is formed from a gemstone, a synthetic or imitation gemstone, or like material including glass or plastic. Top 42 is adhered or mounted to threaded member 44. A RFID tag 6 is disposed within a buffer ring 8, which is then disposed within threaded recess 46. Cap 40 seals RFID tag 6 and buffer ring 8 within the threaded recess 46 when rotatably inserted into the threaded recess 46. In some embodiments, one or more spacers can be included on either side of RFID tag 6 disposed within buffer ring 8. The one or more spacers can be either substantially permissive or substantially inhibiting, as described above.

In the embodiment shown in FIG. 4, ease of access to an enclosed RFID tag provides another means of interchangeability. In some embodiments, rather than changing out the entire command module 20, a user can unscrew cap 40 from ring 48 to remove cap 40, permitting access to and exchange of the enclosed RFID tag 6.

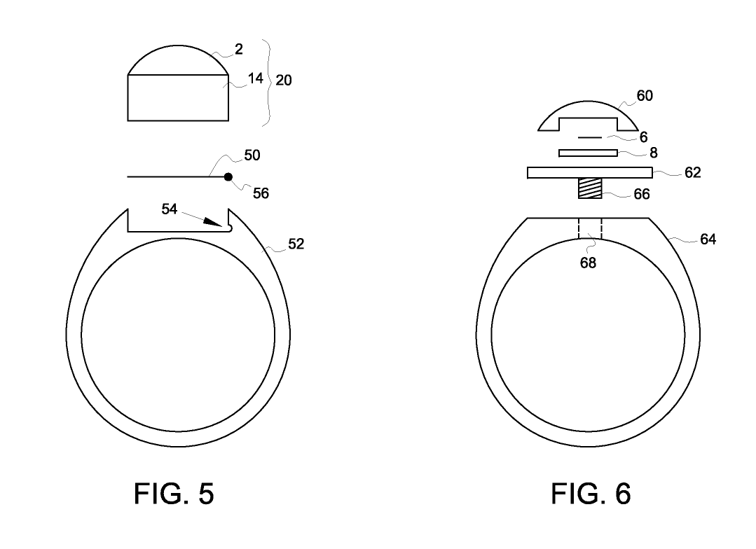

In some embodiments, shown in FIG. 5, the command module 20 is affixed to a modified ring 52 via a retaining clip 50. Retaining clip 50 is shaped to fit about the bottom of housing 14, and has a bulbous protrusion 56 on one side. Retaining clip 50 can also be a standard “C” clip. Once retaining clip 50 is connected to housing 14 using adhesive or simple friction, the entire command module 20 is slid into position, mounted on modified ring 52. The bulbous protrusion 56 is fitted into a groove 54 on modified ring 54, and command module 20 snaps into place on modified ring 52 where it is held by the union of bulbous protrusion 56 and groove 54. In some embodiments, one or more spacers can be disposed within command module 20, on either side of RFID tag 6 disposed within buffer ring 8. The one or more spacers can be either substantially permissive or substantially inhibiting, as described above.

In some embodiments, shown in FIG. 6, a hollow cap 60 is used to hold the RFID tag instead of the previously-described housing. As with previously-described cap 2, hollow cap 60 is formed from a gemstone, a synthetic or imitation gemstone, or like material including glass or plastic. Also, hollow cap 60 has a convex, substantially hemispherical surface and a flat surface. In the alternative, the cap can have a concave surface and a flat surface. Hollow cap 60 has a recess formed in the flat surface to hold an RFID tag 6 and buffer ring 8. In the illustrated embodiment, RFID tag 6 is disposed within buffer ring 8, which is then disposed within hollow cap 60. Hollow cap 60 is then affixed to a bezel setting 62 or similar plate, which has a screw post 66 that is rotatably insertable into a threated slot 68 in ring 64. In some embodiments, one or more spacers can be included on either side of RFID tag 6 disposed within buffer ring 8. The one or more spacers can be either substantially permissive or substantially inhibiting, as described above.

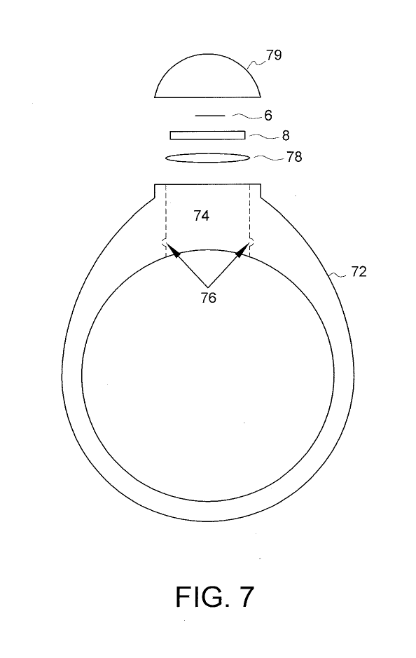

In some embodiments, shown in FIG. 7, a ring 72 has a channel 74 through its top portion. In some embodiments, the channel 74 is cylindrical and includes a notch 76 cut the full circumference of the channel 74. Channel 74 is sized to hold RFID tag 6 disposed within buffer ring 8. Notch 76 is sized to hold bottom retainer 78 in place. Bottom retainer 78 is formed from a flexible material, such as semi-rigid plastic, so it can be inserted and removed from notch 76. The diameter of bottom retainer 78 is larger than the diameter of channel 74 but smaller than the diameter of notch 76, allowing bottom retainer 78 to be held in place when inserted into notch 76. With bottom retainer 78 inserted into notch 76, buffer ring 8 and RFID tag 6 are disposed within channel 74 and sealed in place by cap 79. Cap 79 can be connected to ring 72 by cement, glue, solder, or other suitable adhesive.

In some embodiments, bottom retainer 78 is formed from a material that is substantially permissive of radio frequency transmission and cap 79 is formed from a material that substantially inhibits radio frequency transmissions. In this embodiment, the effective transmission range of RFID tag 6 is greatly limited.

The use of RFID tags has spread to innumerable applications, and embodiments of the present disclosure can be applied in numerous ways. In general use, a RFID tag is read by an RFID reader to transfer data on the tag to the reader. The RFID reader is operatively connected to a computer or other processing system and transfers data from the tag to the computer or processing system for use.

By way of example, RFID tags can be used in a key fob to provide keyless locking and unlocking of a vehicle door. The RFID tag enclosed in the fob uniquely identifies the key associated with a given vehicle. As a driver approaches the vehicle door, a RFID reader located in the door handle, door, or elsewhere in the vehicle reads the identifying information contained on the RFID tag. A processing system uses this identifying information to determine if the key fob is associated with the vehicle and should thus be granted access to the vehicle. If the key fob is positively associated with the vehicle, the processing system sends a signal to the vehicle door to unlock.

Additional uses of the present disclosure are included in Table 1. Table 1 assumes the implementation device (i.e.—vehicle) is equipped with a RFID reader and associated circuitry. The examples in Table 1 are provided for illustrative purposes and are in no way meant to be a full list of potential applications of the present disclosure.

TABLE 1
Applications of the Present Disclosure

Keyless starting of a vehicle
Arming or disarming a security system
Opening, locking, or unlocking a residential or commercial door,
gate, or equivalent
Opening, locking, or unlocking a safe
Enabling operation of a firearm
Payment using credit or debit card information loaded into RFID tag
Opening, locking, unlocking, or starting a personal watercraft,
motorcycle, or machinery
Enabling use of a cellular telephone
Verifying identity at an airport or security checkpoint
Verifying identity, license, insurance status, and vehicle
registration during a traffic stop

The jewelry piece with interchangeable RFID tag disclosed above has several advantages. A jewelry piece provides a convenient and unobtrusive way to carry an RFID tag and is less likely than a badge, key fob, or other RFID tag carrier to be lost or damaged. By making the RFID tag interchangeable through the various means disclosed above, the jewelry piece provides a flexibility to the user to carry with them a range of information. For example, a user can have a jewelry piece with a command module containing an RFID tag loaded with identifying information specific to their professional life, i.e. containing login information for their work computer, access information to their office, etc. That same user could then switch command modules, outfitting the jewelry piece with a second command module loaded with personal information such as identifying information for specific use at a doctor's office. In various circumstances, a user could chose to limit the data they carry within their jewelry piece so as to limit the potential for fraud and identity or information theft. Command modules could also be exchanged for purely aesthetic purposes.

In some embodiments, an apparatus for conveniently carrying a radio frequency identification tag comprises a jewelry piece including a threaded slot for receiving a screw post; a cap with a convex, substantially hemispherical surface and a flat surface, the flat surface connected to a housing including the screw post; a radio frequency identification tag, disposed within a buffer ring which is disposed within the housing; and wherein the housing is operatively connected to the jewelry piece by rotatably inserting the screw post in the threaded slot.

In some embodiments, an apparatus for carrying a radio frequency identification tag within a jewelry ring comprises a jewelry ring including a threaded slot; a bezel setting comprising a flat plate and a screw post, wherein the bezel setting is operatively connected to the jewelry ring by rotatably inserting the screw post into the threaded slot; a cap comprising a convex, substantially hemispherical surface and a flat surface including a recess, and wherein the flat surface is connected to the bezel setting; and a radio frequency identification tag, disposed within a buffer ring which is disposed within the recess of said cap.

In some embodiments, an apparatus for carrying a radio frequency identification tag within a jewelry ring comprises a jewelry ring including a threaded recess; a cap comprising a substantially hemispherical portion and a threaded member portion; and a radio frequency identification tag, disposed within a buffer ring, the buffer ring disposed within the threaded recess wherein the threaded recess encloses the radio frequency identification tag and the buffer ring when the cap is rotatably inserted into the threaded recess.

Although examples are illustrated and described herein, embodiments are nevertheless not limited to the details shown, since various modifications and structural changes can be made therein by those of ordinary skill within the scope and range of equivalents of the claims.

What is claimed is:

1. An apparatus for carrying a radio frequency identification tag, comprising:
a jewelry ring;
a semi-flexible retaining clip having a bulbous protrusion;
a command module comprising:
a cylindrical housing defining a void,
a cap with a convex, substantially hemispherical surface and a flat surface, said flat surface connected to the housing;
a battery-assisted passive radio frequency identification tag configured to transfer a unique identifier to a radio frequency identification reader and disposed within the void of the housing;
a battery in electrical connection with the battery-assisted passive radio frequency identification tag and disposed within the void of the housing;
wherein the jewelry ring comprises a receiving area configured to receive the command module and the retaining clip, said receiving area having a groove configured to receive the bulbous protrusion of the semi-flexible retaining clip; and
wherein the command module is disposed within the receiving area of the jewelry ring and connected to the jewelry ring via the retaining clip.

2. The apparatus of claim 1 further comprising a spacer disposed within the void of the housing.

3. The apparatus of claim 2 wherein the spacer comprises a material which substantially inhibits radio frequency transmissions to reduce the range of the battery-assisted passive radio frequency identification tag.

4. The apparatus of claim 1 wherein the battery-assisted passive radio frequency identification tag is laterally surrounded by a buffer ring.

5. The apparatus of claim 4 wherein the battery-assisted passive radio frequency identification tag has a first thickness and is disposed within a buffer ring having a second thickness, wherein the second thickness is greater than or equal to the first thickness.

6. The apparatus of claim 5 wherein the cap is formed from gemstone, glass, or plastic.

7. A system of carrying a radio frequency identification tag, comprising:
a first command module and a second command module, each comprising:
a cylindrical housing defining a void,
a cap with a convex, substantially hemispherical surface and a flat surface, said flat surface connected to the housing;
a radio frequency identification tag configured to transfer a unique identifier to a radio frequency identification reader, disposed within the void of the housing;
a semi-flexible retaining clip having a bulbous protrusion;
a jewelry ring having a receiving area configured to receive a command module and the retaining clip, said receiving area having a groove configured to receive the bulbous protrusion of the retaining clip; and
wherein the first command module and second command module are interchangeably connected to the jewelry ring using the retaining clip.

8. The system of claim 7 wherein the radio frequency identification tag disposed within the first command module is a passive-type radio frequency identification tag.

9. The system of claim 7 wherein the radio frequency identification tag disposed within the first command module is a battery-assisted passive radio frequency identification tag and wherein a battery is electrically connected to the battery-assisted passive radio frequency identification tag and disposed within the first housing.

10. The system of claim 7 wherein the radio frequency identification tag disposed within the first command module is a passive-type radio frequency identification tag and the radio frequency identification tag disposed within the second command module is an active-type radio frequency identification tag.

11. The system of claim 9 wherein the battery-assisted passive radio frequency identification tag has a readable range between six and thirty-six inches.

12. The system of claim 9 wherein the battery-assisted passive radio frequency identification tag has a readable range between zero and six inches.

13. A method of identification, comprising:
moving a jewelry piece to a distance between zero and six inches from a radio frequency identification reader, said jewelry piece comprising:
an active-type radio frequency identification tag;
a battery in electrical connection with the active-type radio frequency identification tag;
said active-type radio frequency identification tag and battery disposed within a housing selectably disposed within a receiving area formed in a jewelry ring and connected thereto by a semi-flexible retaining clip having a bulbous protrusion, wherein said receiving area has a groove configured to receive the bulbous protrusion of the semi-flexible retaining clip; and
transferring a unique identifier from said active-type radio frequency identification tag to said radio frequency identification reader.

14. The method of claim 13, wherein said radio frequency identification reader is disposed within a car door, and said step of transferring a unique identifier from said active-type radio frequency identification tag to said radio frequency identification reader unlocks the car door if said unique identifier matches with a pre-programmed unique identifier for unlocking the car door.

15. The method of claim 13, wherein said radio frequency identification reader is disposed within a firearm, and said step of transferring a unique identifier from said active-type radio frequency identification tag to said radio frequency identification reader enables operation of the firearm if said unique identifier matches with a pre-programmed unique identifier for enabling operation of the firearm.

16. The method of claim 13, further comprising:
using the transferred unique identifier to retrieve data from a remote database associated with the transferred unique identifier.

17. The method of claim 16, wherein the retrieved data includes one of a driver's license, a driver's insurance status, or a vehicle registration.
